(19) United States
(12) Patent Application Publication
(10) Pub. No.: US 2008/0308593 A1
(43) Pub. Date: Dec. 18, 2008

(54) COMBUSTION TYPE POWER TOOL

(76) Inventors: Yoshitaka Akiba, Ibaraki (JP); Haruhisa Fujisawa, Ibaraki (JP); Yoshimitsu Iijima, Ibaraki (JP); Norikazu Baba, Ibaraki (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/048,582

(22) Filed: Mar. 14, 2008

(30) Foreign Application Priority Data
Mar. 15, 2007 (JP) P2007-066386

(51) Int. Cl. B25C 1/14

(52) U.S. Cl. 227/10

(57) ABSTRACT

The combustion type power tool includes a housing accommodating a combustion chamber and an ignition plug for igniting a combustion gas supplied into the combustion chamber. In the housing is defined a lithium ion battery accommodating part for causing the ignition plug to generate ignition energy. The housing includes a handle part. The lithium ion battery accommodating part is arranged at the free end of the handle part.

### CROSS-REFERENCE TO RELATED APPLICATIONS

This application is based on and claims the benefit of priority from the prior Japanese Patent Application No. 2007-066386, filed on Mar. 15, 2007; the entire contents of which are incorporated herein by reference.

### TECHNICAL FIELD

The present invention relates to a combustion type power tool and in particular to a combustion type power tool for driving a stopper into a material to be driven in with the combustion/explosion energy of a combustion gas.

### BACKGROUND

An example of combustion type power tool is a nailing machine disclosed in JP-A-2005-329533. The nailing machine includes, in a housing constituting a profile, a cylinder, a piston, and a movable combustion chamber frame. When the combustion chamber frame has moved to a predetermined position, the combustion chamber is defined. A fan is rotatably arranged in the combustion chamber. To the piston is fixed a driver plate for driving a stopper, thus forming a power part to be driven by the combustion and explosion of a combustible gas in the combustion chamber. On the tip of the housing is provided an injecting part for holding a stopper in position in order to transmit the power of the power part to the stopper and letting the driver plate to pass through. The housing includes a handle part. Between the handle part and the injecting part is arranged a magazine for supplying a stopper to the injecting part. To ignite a combustion gas supplied to the combustion chamber, an ignition plug to make a spark is arranged facing the combustion chamber. In the handle is accommodated a nickel-cadmium battery or a nickel metal hydride battery as a battery for storing electric energy to rotate a fan and make a spark.

### SUMMARY

The nailing machine is used with its handle grasped by the user's hand. The nailing machine is desirably light-weight for reduced fatigue of the user and better workability. Related art nailing machines use a nickel-cadmium battery or a nickel metal hydride battery, which adds to the overall weight of a power tool, resulting in poor handling. Thus, improved workability has been requested of such a related art power tool. The nickel-cadmium battery or a nickel metal hydride battery has a short cycle life, that is, a small count of repeated use. This results in a higher running cost.

An object of the invention is to provide a combustion type power tool having a reduced overall weight and capable of enhancing workability by providing appropriate weight distribution during work thus reducing the running cost.

To attain the object, the invention provides a combustion type power tool comprising a housing accommodating a combustion chamber and ignition means for igniting a combustion gas supplied into the combustion chamber, characterized in that a lithium ion battery accommodating part for causing the ignition means to generate ignition energy is defined in the housing.

The power tool preferably comprises a power part driven by the combustion and explosion of a combustion gas in the combustion chamber, an injecting part for holding a stopper in position in order to transmit the power of the power part to the stopper, and a magazine for supplying a stopper to the injecting part. Preferably, the housing includes a body accommodating the power part and including the injecting part at the tip thereof and a handle part for grasping the body and the lithium ion battery accommodating part is arranged at the free end of the handle part.

In this case, preferably, the magazine is arranged across the injecting part and the handle end and the end face of the magazine opposed to the handle end and the end face of the handle end form a nearly continuous linear shape without a shoulder part.

The power tool of claim 1 includes, in the housing, a lithium ion battery accommodating part and thus uses a lithium ion battery as a battery source. This contributes to reduction in overall weight of the combustion type power tool. A lithium ion battery shows a smaller amount of discharge and longer service life than a nickel-cadmium battery or a nickel metal hydride battery, thus reducing the running cost. A lithium ion battery is excellent in terms of recycling property and its use contributes to effective usage of resources.

In general, a nailing machine as a representative example of a combustion type power tool is often used to drive a nail downward in perpendicular direction. According to the combustion type power tool of claim 2, the lithium ion battery accommodating part is arranged at the free end of the handle part. Thus, when a nail is driven downward in perpendicular direction with a lithium ion battery loaded in the battery accommodating part, it is possible to provide weight distribution further biased toward the injecting part, placed apart from the handle, just above a material to be driven in because the lithium ion battery is lightweight as compared to the nickel-cadmium battery or the nickel metal hydride battery. This makes it possible to further concentrate the weight of the tool in driving onto the driver plate thus reducing the reaction of driving force and enhancing the work efficiency.

According to the combustion type power tool of claim 3, the end face of the magazine opposed to the handle end and the end face of the handle end form a nearly continuous linear shape without a shoulder part. The shape has no surface irregularities. It is thus possible to perform work in a narrower space while avoiding interference with the surroundings.

### BRIEF DESCRIPTION OF THE DRAWINGS

FIG. 1 is a cross-sectional view of a combustion type power tool according to an embodiment of the invention.

### DESCRIPTION OF THE EMBODIMENTS

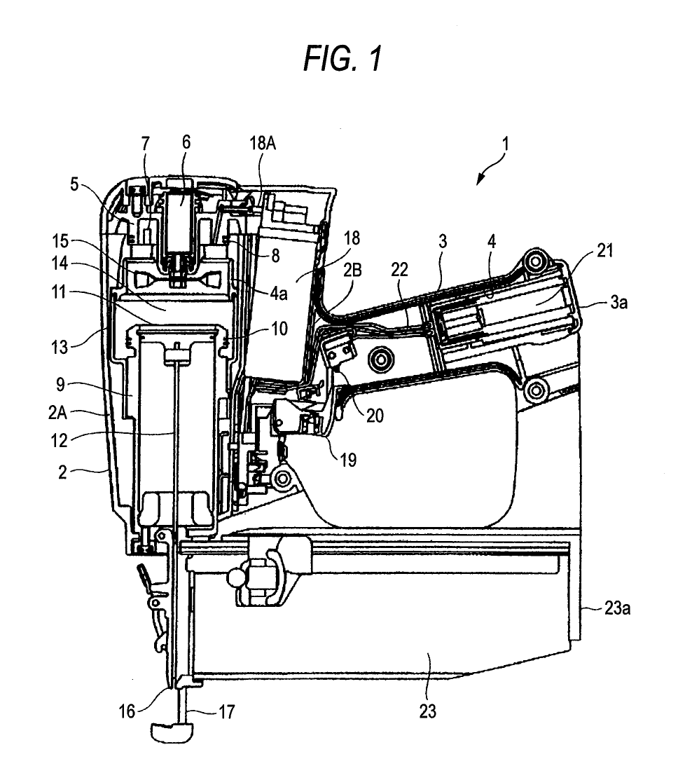

An example where a combustion type power tool according to the first embodiment of the invention is applied to a nailing machine will be described referring to FIG. 1. A nailing machine 1 includes a housing 2 as a profile. The housing 2 includes a housing body 2A, a gas cylinder accommodating part 2B located at the side of the housing body 2A, and a handle part 3 extending from the gas cylinder accommodating part 2B. In a position inside the housing body 2A close to one end thereof is arranged a chamber head 5. On the chamber head 5 are supported a motor 6 and an ignition plug 7 as ignition means, On the outer circumference face of the chamber head 5 is mounted a head seal part 8. Inside the chamber head 5 is formed a combustion gas passage.

Inside the housing body 2A is fixed a cylinder 9 in a position opposite to a motor 6. On the outer circumference face of the cylinder 9 at one end is mounted a cylinder seal part 10. Inside the cylinder 9 is arranged a piston 11 as a power part in a slidably reciprocating fashion with respect to the cylinder 9. A driver plate 12 for driving a nail as a stopper extends from the piston 11 to the other end of the housing body 2A.

Inside the housing body 2A is arranged a combustion chamber frame 13 movable in the axial direction of the cylinder 9. In accordance with the current position of the combustion chamber frame 13, its inner circumference face is sealed to the head seal part 8 and the cylinder seal part 10. When the combustion chamber frame 13 has moved toward one end of the housing body 2A and is seated on the chamber head 5, the chamber head 5, the combustion chamber frame 13, and one end face of the piston 11 define the combustion chamber 14 via the head seal part 8 and the cylinder seal part 10. The above-mentioned ignition plug 7 and the opening end of the combustion gas passage face the combustion chamber 14. A fan 15 fixed to the rotation axis of the motor 6 is rotatably arranged in the combustion chamber 14.

At the other end of the housing body 2A is provided an injecting part 16 for letting a driver plate 12 to pass through in order to transmit the power of the driver plate 12 to a nail and holding the nail in position. On the injecting part 16 is movably supported an activating member 17 moving while pushed by a material to be driven in. To the activating member 17 is connected the combustion chamber frame 13. The combustion chamber frame 13 moves between its top dead center and bottom dead center in coordination with the movement of the activating member 17.

Inside the gas cylinder accommodating part 2B is accommodated a gas cylinder 18 storing a fuel gas and including a nozzle ISA. The nozzle 18A is arranged to be selectively communicable to the fuel passage of the chamber head 5. Also arranged is a cam (not shown) that pushes the gas cylinder 18 when the activating member 17 has received upward pressing force. In case the gas cylinder 18 is pushed by the cam, a fuel gas from the cylinder nozzle 18A is injected into the combustion chamber 14 via the fuel gas passage.

A trigger 19 is mounted, in an operable fashion with fingers, on the handle part 3. Inside the handle part 3 is arrange a spark switch 20 to connect to the ignition plug 7. Inside the space in the handle part 3 near the free end is arranged a lithium ion battery accommodating part 4 for detachably accommodating a lithium ion battery 21. The lithium ion battery 21 is connected to the spark switch 20 and the motor 6 via wiring 22.

Across the injecting part and the handle part 3 is arranged a magazine 23 for sequentially supplying a bundle of nails to the injecting part 16. The end face 23a of the magazine 23 opposed to the handle end and the end face 3a of the handle end form a nearly continuous linear shape without a shoulder part. The shape has no surface irregularities. It is thus possible to perform work in a narrower space while avoiding interference with the surroundings.

In this configuration, when the combustion chamber frame 13 is at the bottom dead center, the combustion chamber frame 13 is not in contact with the head seal part 8 or cylinder seal part 10, so that the space in the combustion chamber frame 13 is communicated to outside air. In this state, when the activating member 17 is abutted against a material to be driven in and the tool 1 is pressed in the direction of the material to be driven in, the combustion chamber frame 13 moves toward the chamber head 5 and comes into close contact with the head seal part 8 and the cylinder seal part 10 to define a combustion chamber 14 shielded from outside air. When the combustion chamber frame 13 rises to a predetermined position, the rise is detected by a sensor (not shown), which rotates the fan 15. With the upward pressing force of the activating member 17, a cam (not shown) pushes the gas cylinder 18 thus causing a fuel gas to be injected from the gas cylinder nozzle 18A into the combustion chamber 14.

When the trigger 19 is pulled with the combustion chamber 14 positioned at the top dead center, the spark switch 20 is turned ON and a spark is generated from the ignition plug 7. This ignites the combustion gas in the combustion chamber 14 and the gas is combusted and exploded to urge the piston 11 in the direction of the injecting part 16. The driver plate 12 hammers the nail in the injecting part 16 to drive the nail into the material to be driven in.

The handle part 3 as a portion of the housing 2 includes a lithium ion battery accommodating part 4. A lithium ion battery 21 is used as a battery source, which contributes to a lightweight design of the entire tool 1. A lithium ion battery 21 shows a smaller amount of discharge and longer service life than a nickel-cadmium battery or a nickel metal hydride battery, thus reducing the running cost. A lithium ion battery is excellent in terms of recycling property and its use contributes to effective usage of resources.

During nailing operation, the nailing machine 1 is often used to drive a nail downward in perpendicular direction. The lithium ion battery accommodating part 4 is arranged at the free end of the handle part 3. When a nail is driven downward in perpendicular direction with a lithium ion battery 21 loaded in the battery accommodating part 4, it is possible to provide weight distribution further biased toward the injecting part 16, placed apart from the handle part 3, just above a material to be driven in because the lithium ion battery is lightweight as compared to the nickel-cadmium battery or the nickel metal hydride battery. This makes it possible to further concentrate the weight of the tool 1 in driving onto the driver plate 12 thus reducing the reaction of driving force and enhancing the work efficiency.

The combustion type power tool of the invention is not limited to the above embodiment but may be modified in various ways without departing from the spirit of the invention. For example, while a lithium ion battery is arranged at the handle end in order to improve the weight balance of the tool during driving practice in the above embodiment, the battery accommodating part may be arranged in parallel with the combustion chamber frame or the injecting part, or included in the magazine as long as a lithium ion battery is used as a battery source and as long as the weight balance of the tool is provided.

The combustion type power tool of the invention is preferably used for a nailing machine.

What is claimed is:

1. A combustion type power tool comprising;
a housing accommodating a combustion chamber; and
ignition means for igniting a combustion gas supplied into the combustion chamber,
wherein a lithium ion battery accommodating part for causing the ignition means to generate ignition energy is formed in the housing.

2. The combustion type power tool according to claim 1, further comprising:
a power part driven by a combustion of the combustion gas and explosion of the combustion gas which are generated in the combustion chamber,
an injecting part for holding a stopper in position in order to transmit the power of the power part to the stopper, and
a magazine for supplying a stopper to the injecting part, wherein the housing includes a body accommodating the power part and including the injecting part at the tip thereof and a handle part for grasping the body, and
wherein the lithium ion battery accommodating part is arranged at a free end of the handle part.

3. The combustion type power tool according to claim 2, wherein the magazine is arranged across the injecting part and the handle end, and
wherein the end face of the magazine opposed to the handle end and the end face of the handle end form a nearly continuous linear shape without a shoulder part.
